(19) United States
(12) Patent Application Publication
(10) Pub. No.: US 2009/0217060 A1
(43) Pub. Date: Aug. 27, 2009

(54) POWER SUPPLY CONTROL DEVICE

(76) Inventor: JUNICHIRO TSUCHIYA, Tokyo (JP)

Correspondence Address: NEC CORPORATION OF AMERICA, 6535 N. STATE HWY 161, IRVING, TX, 75039, US

(21) Appl. No.: 12/389,650

(22) Filed: Feb. 20, 2009

(30) Foreign Application Priority Data
Feb. 21, 2008 (JP) 2008-039790

(51) Int. Cl. G06F 1/00; H02J 3/00

(52) U.S. Cl. 713/300; 307/80

(57) ABSTRACT

To improve the efficiency of power supply units, and save the power of a device. A power supply control device for controlling on/off of a plurality of power supply units which supply power to a device, includes: a necessary power amount obtaining device which obtains a necessary power amount that shows a value of a power amount required by the device; a power supply unit specifying device which extracts combinations of a single or a plurality of power supply units capable of supplying the necessary power amount based on power amount-efficiency tables, calculates an efficiency of the power amount supplied to the device from the power supply units of the respective combinations, and specifies a combination of the power supply units whose calculated efficiencies satisfy a preset condition; and a power supply controller which controls the power supply units in specified combination to supply the power to the device.

### CROSS-REFERENCE TO RELATED APPLICATION

This application is based upon and claims the benefit of priority from Japanese patent application No. 2008-039790, filed on Feb. 21, 2008, the disclosure of which is incorporated herein in its entirety by reference.

### BACKGROUND OF THE INVENTION

1. Field of the Invention

The present invention relates to a power supply control device and, more specifically, to a power supply control device which controls on/off of a plurality of power supply units capable of supplying power to a device.

2. Description of the Related Art

In business firms and the like, there is used a composite computer device which includes a plurality of CPU modules having a processor, a memory, a storage device, and the like as a server computer such as a database server, an application server, a Web server, etc. The composite computer device has a plurality of power supply units, and the power supplies are so controlled that a necessary number of power supply units are used according to the structure and working condition of the composite computer device.

For example, Patent Document 1 (Japanese Unexamined Patent Publication 2006-302059) discloses a technique which monitors the structure and working condition of a composite computer device, calculates the number of power supply units required for the operation of the device, and starts the output of the necessary number of power supply units based thereupon. Further, Patent Document 2 (Japanese Unexamined Patent Publication 2007-26083) discloses a method which estimates the power consumption based on the operation state of the device, compares the efficiency of the power supply of an information processor with the efficiency of the power supply of a device that can feed the power, and selects the power supply with the higher efficiency. Normally, the number of power supply units loaded on a device is determined based on the maximum power consumption of the device. However, efficiency of a power supply circuit is normally poor in a low load state. The above-described techniques make it possible to have only the necessary smallest number of power supply unit(s) required for the operation of the device output the power when only a part of the device is operating, so that the efficiency of the power supply can be improved by increasing the load of the power supply unit(s).

However, the technique disclosed in Patent Document 1 only utilizes such a typical rule that the efficiency of a power supply circuit is poor in a low load state, so that differences in each of the power supply units are not reflected upon the control. Therefore, the efficiency of the power supply units cannot be improved to the best, and the power consumption of the composite computer device cannot necessarily be decreased. In addition, as described above, the differences in each of the power supply units are not reflected upon the control. Thus, if a power supply unit whose efficiency has become deteriorated is used, the supplied power may become insufficient in some cases. Thereby, the composite computer device may become incapable of operation.

Further, while the technique disclosed in Patent Document 2 makes it possible to select the one optimum power supply by considering the efficacies of the power supplies, there may be cases where not necessarily the use of a single power supply provides the optimum efficiency. Therefore, it may not be still possible with this technique to optimize the power supply efficiency.

### SUMMARY OF THE INVENTION

An exemplary object of the present invention therefore is to achieve highly efficient use of power supply units and to save the power of a device.

In order to achieve the foregoing exemplary object, the power supply control device according to an exemplary aspect of the invention is a power supply control device for controlling on/off of a plurality of power supply units which supply power to a device. The power supply control device includes: a necessary power amount obtaining device which obtains a necessary power amount that shows a value of a power amount required by the device; a power supply unit specifying device which extracts combinations of a single power supply unit or of a plurality of power supply units capable of supplying the necessary power amount based on power amount-efficiency tables that show efficiencies of power amounts that can be outputted from each of the power supply units, calculates an efficiency of the power amount that is supplied to the device from each of the power supply units of the respective combinations, and specifies a combination of the power supply units whose calculated efficiencies satisfy a preset condition; and a power supply controller which executes a control in such a manner that the power is supplied to the device from the power supply units that configure the specified combination.

Further, the power supply mounted device according to another exemplary aspect of the invention is an application example of the power supply control device. It is a power supply mounted device which includes power supply units, a power supplied device which operates by receiving supply of power from the power supply units, and a power supply control device which controls on/off of the power supply units, wherein:

each of the power supply units stores a power amount-efficiency table which shows an efficiency of a power amount that can be outputted therefrom; and

the power supply control device includes a necessary power amount obtaining device which obtains a necessary power amount that shows a value of a power amount required by the device,

a power supply unit specifying device which extracts combinations of a single power supply unit or of a plurality of power supply units capable of supplying the necessary power amount based on the power amount-efficiency tables, calculates an efficiency of the power amount that is supplied to the device from each of the power supply units of the respective combinations, and specifies a combination of the power supply units whose calculated efficiencies satisfy a preset condition, and

a power supply controller which executes a control in such a manner that the power is supplied to the power supplied device from the power supply units that configure the specified combination.

Further, the power supply control program according to still another exemplary aspect of the invention allows a power supply control device, which controls on/off of a plurality of power supply units capable of supplying power to a prescribed device, to execute:

a function which obtains a necessary power amount that shows a value of a power amount required by the device,

a function which extracts combinations of a single power supply unit or of a plurality of power supply units capable of supplying the necessary power amount based on the power amount-efficiency tables, calculates an efficiency of the power amount that is supplied to the device from each of the power supply units of the respective combinations, and specifies a combination of the power supply units whose calculated efficiencies satisfy a preset condition, and

a function which executes a control in such a manner that the power is supplied to the power supplied device from the power supply units that configure the specified combination.

Furthermore, the power supply control method according to still another exemplary aspect of the invention is a power supply control method for controlling on/off of a plurality of power supply units capable of supplying power to a prescribed device. The method executes:

a necessary power amount obtaining step which obtains a necessary power amount that shows a value of a power amount required by the device,

a power supply unit specifying step which extracts combinations of a single power supply unit or of a plurality of power supply units capable of supplying the necessary power amount based on the power amount-efficiency tables, calculates an efficiency of the power amount that is supplied to the device from each of the power supply units of the respective combinations, and specifies a combination of the power supply units whose calculated efficiencies satisfy a preset condition, and

a power supply control step which executes a control in such a manner that the power is supplied to the power supplied device from the power supply units that configure the specified combination.

### BRIEF DESCRIPTION OF THE DRAWINGS

FIG. 1 is a block diagram showing the structure of a composite computer device according to a first exemplary embodiment;

FIG. 2 is a functional block diagram showing the structure of a BMC disclosed in FIG. 1;

FIG. 3 is a functional block diagram showing the structure of a management module disclosed in FIG. 1;

FIG. 4 is an illustration showing an example of a power supply unit efficiency table disclosed in FIG. 1;

FIG. 5 is a graph of the power supply unit efficiency table disclosed in FIG. 4;

FIG. 6 is a flowchart showing operations of the entire composite computer device according to FIG. 1;

FIG. 7 is a flowchart showing operations when the management module of the composite computer device according to the first exemplary embodiment specifies a combination of the power supply units; and

FIG. 8 is a block diagram showing the structure of a composite computer device according to a second exemplary embodiment.

### DETAILED DESCRIPTION OF THE EXEMPLARY EMBODIMENTS

Hereinafter, exemplary embodiments of the invention will be described in detail by referring to the accompanying drawings.

In a device having a plurality of power supply units, the present invention execute a control in such a manner that the power supply units are turned on to reduce wasteful power consumption through suppressing deterioration of the power efficiency, even when there are changes in the working condition of the device and the property of the power supply units.

A power supply control device as an exemplary embodiment of the invention is a power supply control device for controlling on/off of a plurality of power supply units which supply power to a device. The power supply control device includes: a necessary power amount obtaining device which obtains a necessary power amount that shows a value of a power amount required by the device; a power supply unit specifying device which extracts combinations of a single power supply unit or of a plurality of power supply units capable of supplying the necessary power amount based on power amount-efficiency tables that show efficiencies of power amounts that can be outputted from each of the power supply units, calculates an efficiency of the power amount that is supplied to the device from each of the power supply units of the respective combinations, and specifies a combination of the power supply units whose calculated efficiencies satisfy a preset condition; and a power supply controller which executes a control in such a manner that the power is supplied to the device from the power supply units that configure the specified combination.

Further, this exemplary embodiment employs such a structure that the power supply unit specifying device calculates an overall efficiency of the whole power supply units that configure each of the combinations based on the calculated efficiencies of each of the power supply units, and specifies the combination whose overall efficiency satisfies a preset condition. Furthermore, the power supply unit specifying device specifies the combination of the power supply units that include the unit whose calculated efficiency is the highest or the combination whose calculated overall efficiency is the highest. Moreover, the power supply unit specifying device calculates an efficiency that corresponds to a power amount obtained by dividing the necessary power amount by number of the power supply units configuring the combination, as the efficiency of each of the power supply units.

Further, this exemplary embodiment employs such a structure that the necessary power amount obtaining device obtains device information that shows a structure and an operating condition of the device, calculates a power consumption amount of the entire device based on the device information, and obtains the calculated power consumption amount as the necessary power amount. Furthermore, when the device is a composite computer device including a plurality of computer modules having at least a processor and a memory, the necessary power amount obtaining device calculates power consumption of each of the computer modules, respectively, and calculates an overall power consumption amount of the entire composite computer device.

The power supply control device according to the exemplary embodiment of the invention described above first obtains the necessary power amount that is the data indicating the value of the power amount required by the device. For example, the power supply control device calculates the amount of the power consumed in each structure that configures the device and the amount of power consumed by the entire device, and obtains those as the necessary power amount. Subsequently, the power supply control device extracts all the combinations of the power supply unit (s) (may be a single power supply unit or a plurality of power supply units) capable of supplying the obtained necessary power amount based on a power amount-efficiency table of each power supply unit stored in a prescribed storage part such as a storage within the power supply unit. Then, based on the power amount-efficiency table, the efficiency corresponding to the power amount that is supplied to the device by each power supply unit is calculated for each of the combinations. In a case of a combination with a plurality of power supply units, for example, the overall efficiency of the combination of the plurality of power supply units as a whole is calculated based on the calculated efficiencies of each power supply unit. Then, the power supply control device specifies the combination of the power supply units satisfying a preset condition, e.g., the combination whose calculated efficiency (or calculated overall efficiency) is the highest. Thereafter, the power supply control device controls on/off of a single power supply unit or a plurality of power supply units configuring the specified combination to supply the power therefrom.

Through the above operations, the power supply control device can supply the power amount required for the device, and controls on/off of the power supply units by specifying the combination of the power supply units of the optimum efficiency. Therefore, it is possible to achieve the highly efficient use of the power supply units, thereby making it possible to increase the life of the power supply units and to decrease the power consumption.

Further, the above-described power supply controller includes a table updating device which obtains values of input power amount and output power amount of each power supply unit, respectively, and updates the power amount-efficiency table of each power supply unit. Thereby, the power amount-efficiency tables are updated according to secular changes and the like of each power supply unit. Therefore, it is possible to specify the power supply unit of the optimum efficiency by corresponding to the conditions of the power supply units at each point and time. This makes it possible to use the power supply units still more efficiently.

Further, this exemplary embodiment employs such a structure that the power supply unit specifying device specifies a combination that is obtained by adding still another power supply unit to a single power supply unit or a plurality of the power supply units configuring the specified combination. Furthermore, the power supply unit specifying device specifies a combination that is obtained by adding still another power supply unit, which can be substituted for any of the power supply units configuring the combination, to a single power supply unit or a plurality of the power supply units configuring the specified combination. Moreover, the power supply unit specifying device specifies a combination with which, when a prescribed power supply unit among a single power supply unit or a plurality of the power supply units configuring the specified combination becomes out of order, the necessary amount can be supplied to the device with remaining power supply units.

With this, the power supply units for supplying the power to the device can be in a redundant structure. Thus, it is possible to stabilize supply of the power while improving the efficiency of the power supply units and decreasing the power consumption, as described above. As a result, reliability of the device can be improved.

Further, a power supply mounted device according to an exemplary embodiment of the present invention to which the power supply control device is applied is a power supply mounted device which includes power supply units, a power supplied device which operates by receiving supply of power from the power supply units, and a power supply control device which controls on/off of the power supply units. Each of the power supply units stores a power amount-efficiency table which shows an efficiency of a power amount that can be outputted therefrom. Further, the power supply control device includes: a necessary power amount obtaining device which obtains a necessary power amount that shows a value of a power amount required by the device; a power supply unit specifying device which extracts combinations of a single power supply unit or of a plurality of power supply units capable of supplying the necessary power amount based on the power amount-efficiency tables, calculates an efficiency of the power amount that is supplied to the device from each of the power supply units of the respective combinations, and specifies a combination of the power supply units whose calculated efficiencies satisfy a preset condition; and a power supply controller which executes a control in such a manner that the power is supplied to the power supplied device from the power supply units that configure the specified combination.

Further, this exemplary embodiment employs such a structure that each of the power amount-efficiency tables is stored within the respective power supply units. With this, the power supply control device can specify the combination of the power supply units based in the power amount-efficiency tables stored in the power source units. Therefore, it is possible to refer to the tables that are stored in the power source units, even if a power supply unit for a power supply mounted device is exchanged. Thus, the structure of the power supply mounted device can be changed easily.

Hereinafter, specific structures and operations of the present invention will be described by referring to the exemplary embodiments. A composite computer device having a plurality of CPU modules will be described in the followings as an example of a power supply mounted device to which power supply units are mounted. However, the power supply mounted device is not limited to the composite computer device but may be of any kinds.

### First Exemplary Embodiment

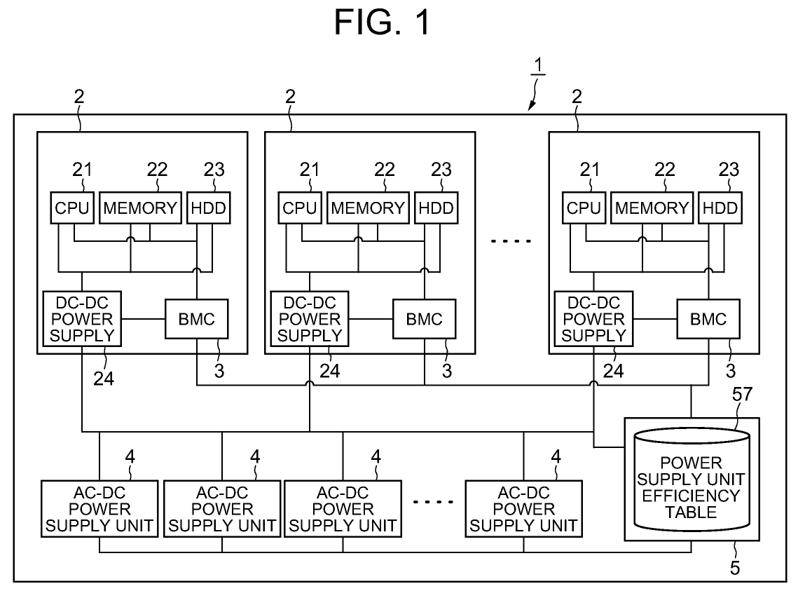

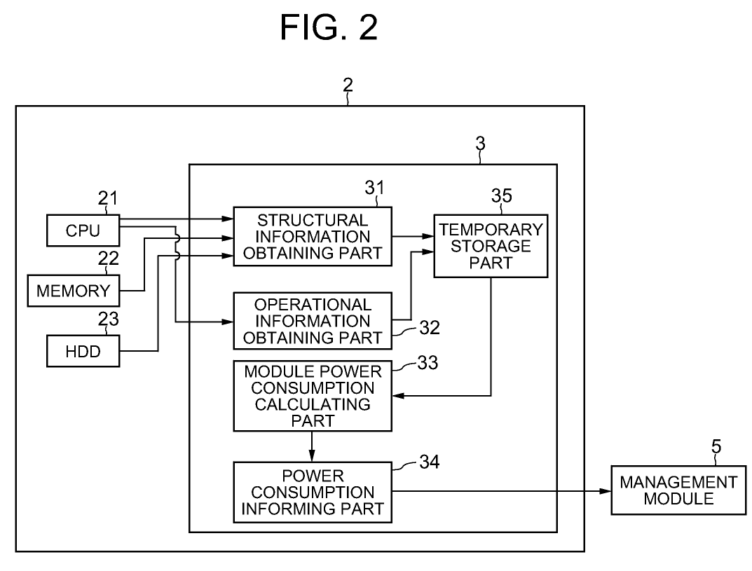

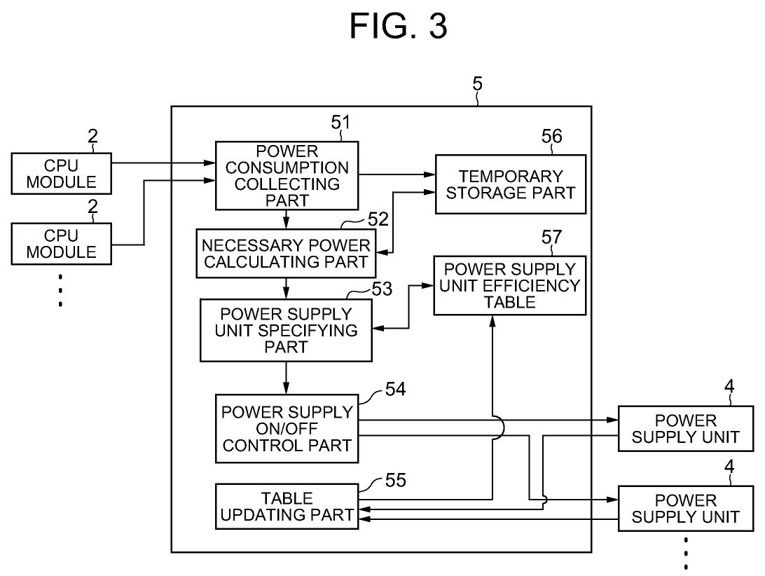

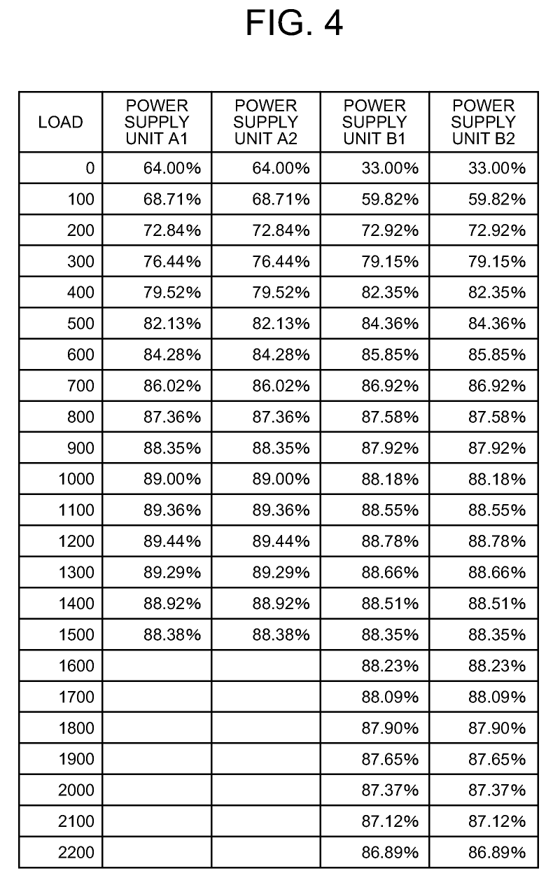

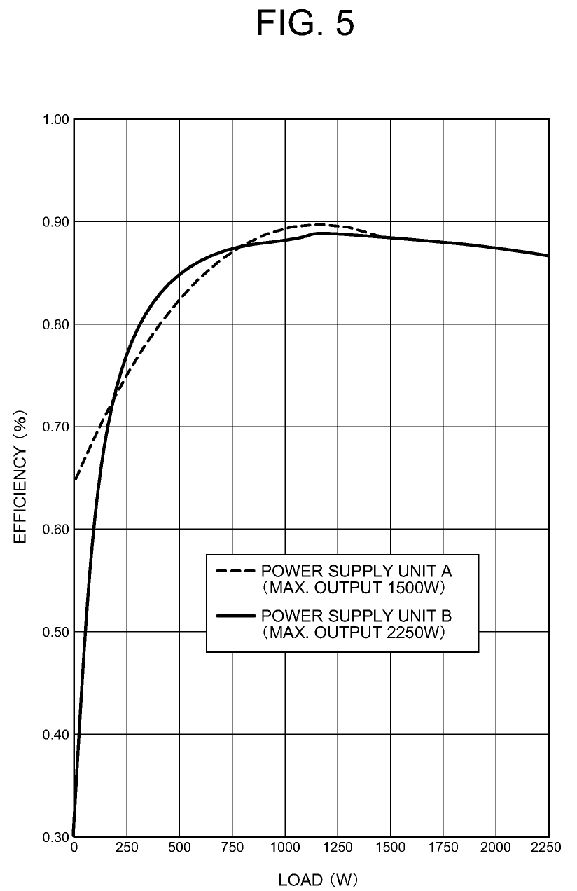

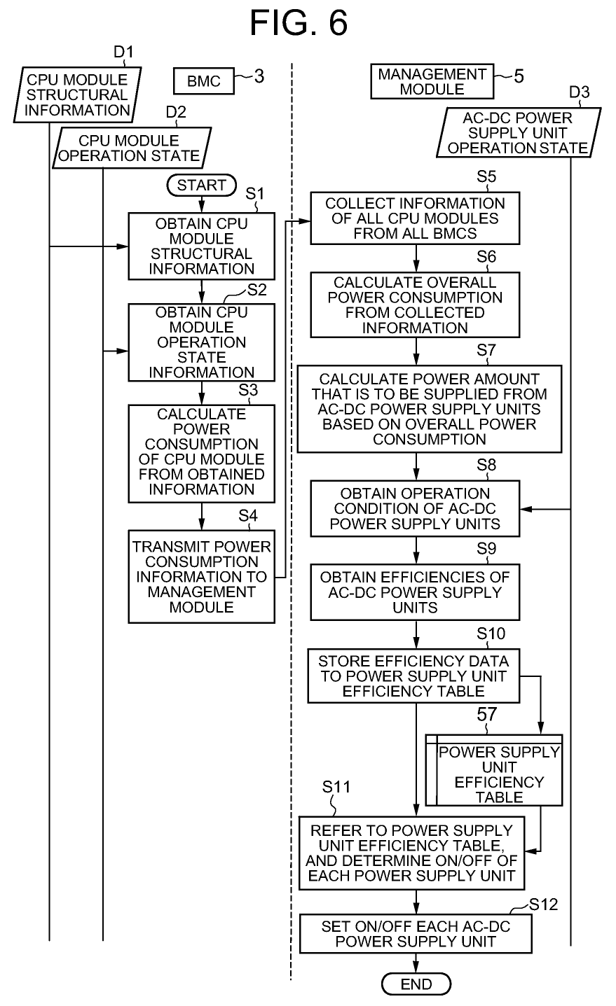

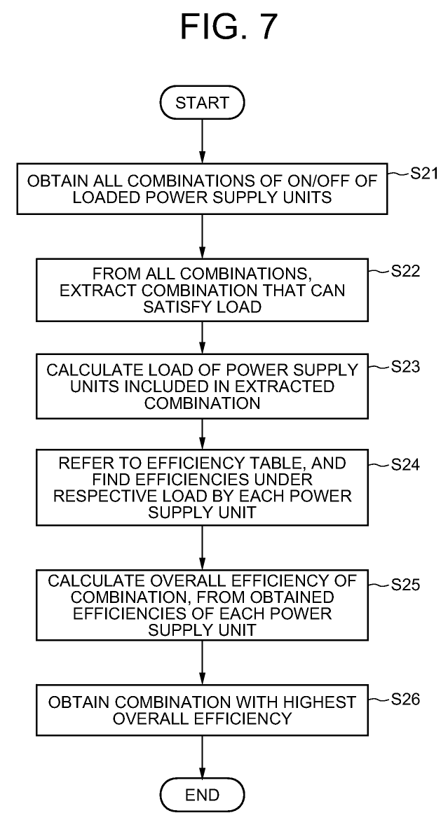

Next, the exemplary embodiments of the invention will be described in a more concretive manner. A first exemplary embodiment of the invention will be described by referring to FIG. 1-FIG. 7. FIG. 1 is a functional block diagram showing the structure of a composite computer device. FIG. 2 is a functional block diagram showing the structure of a BMC. FIG. 3 is a functional block showing the structure of a management module. FIG. 4 and FIG. 5 are illustrations showing examples of a power supply unit efficiency table. FIG. 6 and FIG. 7 are flowcharts showing the operations of the composite computer device.

### (Structure)

FIG. 1 shows the structure of the composite computer device according to the exemplary embodiment. As shown in FIG. 1, a composite computer device 1 is a computer such as a blade server which includes a plurality of CPU modules 2, a plurality of AC-DC power supply units 4, and a management module 5. For example, the composite computer device 1 is provided with eight CPU modules 2 and four AC-DC power supply units 4. Each structure will be described in detail hereinafter.

First, the AC-DC power supply unit 4 is a power supply device for supplying power to DC-DC power supplies of the CPU modules 2 to be described later and to the management module 5. It is assumed that there are four AC-DC power supply units 4 in this exemplary embodiment. Specifically, as will be described later, four power supply units 4 in total (units of two each with different kinds of performances) are provided.

Further, each of the above-described CPU modules 2 is a computer module which includes a CPU 21 as a processor, a memory 22 as a storage part, a hard disk drive (HDD) 23, and a DC-DC power supply 24. Furthermore, each of the CPU modules 2 is provided with a BMC (Baseboard Management Controller) 3 for monitoring the operating state of each of the structural parts of the CPU module 2.

The structure of the BMC 3 will now be described in detail by referring to FIG. 2. As shown in FIG. 2, the BMC 3 includes a structural information obtaining part 31, an operational information obtaining part 32, a module power consumption calculating part 33, and a power consumption informing part 34, which are built by having a prescribed program installed to an arithmetic operation part provided within the BMC.

The structural information obtaining part 31 obtains CPU structural information (device information) which shows the structure of the CPU modules 2, and stores it to a temporary storage part 35 that is a storage part provided within the BMC 3. Specifically, the structural information obtaining part 31 obtains the CPU module structural information which shows the details of each structure such as the loaded number of CPUs, the types of the CPUs, the loaded number of memories, and the loaded number of HDDs based on each of the structural elements such as the CPU 21, the memory 22, the HDD 23, and the DC-DC power supply 24 which are provided within the same CPU module 2.

Further, the operational information obtaining part 32 obtains CPU module operation state information which shows the working conditions of each structure of the CPU modules 2, and stores it to the temporary storage part 35 that is a storage part provided within the BMC 3. Specifically, the operational information obtaining part 32 obtains the CPU module operation state information which shows the details of working conditions such as the on/off state of the CPU 21, the operation clock of the CPU 21, and whether or not the CPU 21 is in a power saving mode based on each of the structural elements such as the CPU 21, the memory 22, the HDD 23, and the DC-DC power supply 24 which are provided within the same CPU module 2.

Further, the module power consumption calculating device 33 calculates the value of the power consumption amount of the whole CPU modules 2 based on the CPU module structural information and the CPU module operation state information obtained from each of the structural elements such as the CPUs 21 and the memories 23 in the manner described above, and informs it to the power consumption informing part 34. The calculating formula for calculating the power consumption amount is set in advance by having the obtained CPU module information such as the loaded numbers of the CPUs and memories, the operation clock, etc. as the parameters, and it is stored in the BMC 3 in advance. Thereby, the BMC 3 can calculate the power consumption amount of the CPU modules 2 by using the calculating formula. Then, the power consumption amount informing part 34 informs the power consumption amount of the CPU module that is calculated and informed by the module consumed amount calculating part to the management module 5.

As described above, the BMC 3 has the functions of: obtaining the CPU module information (device information) which shows the structure and the operating condition of the CPU module; calculating the power consumption amount of the CPU module 2; and informing it to the management module. As will be described later, the BMC 3 functions as a necessary power amount calculating device which calculates the necessary power amount of the composite computer device 1 in cooperation with the management module, as will be described later. Note here that it is not necessarily limited that the BMC 3 calculates the power consumption amount of the CPU module 2 by the method described above. That is, the BMC 3 may calculate the power consumption amount of the CPU module 2 by other methods, and inform it to the management module 5.

Then, the management module 5 functions as a power supply controller which monitors the operating condition of the above-described AC-DC power supply units 4 and controls on/off of the AC-DC power supply units 4 by using the information transmitted from the BMC 3. Specifically, the management module 5 includes a power consumption collecting part 51, a necessary power calculating part 52, a power supply unit specifying part 53, a power supply on/off control part 54, and a table updating part 55, which are built by having a prescribed program installed to the arithmetic operation part provided within the management module 5 as shown in FIG. 3. Further, the management module 5 includes a temporary storage part 56 and a power supply unit efficiency table 57 formed in the storage part provided within the management module 5. Hereinafter, each of the structures will be described in detail.

The power consumption collecting part 51 has a function of collecting the values of the power consumption amounts by each of the CPU modules 2 transmitted respectively from the BMCs 3 of the respective CPU modules 2 as described above, and storing those to the temporary storage part 56.

Further, the necessary power calculating part 52 calculates the power consumption amount of the entire composite computer device 1 based on the power consumption amounts of each of the CPU modules 2 collected by the power consumption collecting part 51 in the manner described above. At this time, the power consumption amount of the entire composite computer device 1 is calculated by adding up the power consumption amounts of each of the CPU modules 2 and the power consumption amounts of the other structural elements of the composite computer device 1, for example. Further, the necessary power calculating part 52 calculates the necessary power amount that is required by the composite computer device 1 (i.e., the power amount that needs to be supplied from the AC-DC power supply units 4) based on the power consumption amount of the entire composite computer device 1 calculated in the manner described above. As the necessary power amount, the calculated power consumption amount of the entire composite computer device 1 is used as it is as the necessary power amount, for example. However, calculation of the necessary power amount is not limited only to the above-described method. As the necessary power amount, it is also possible to calculate a value obtained by adding, to the power consumption amount, the power amount that can be supplied from a prescribed power supply unit.

In the manner described above, the management module 5 obtains the necessary power amount that shows the value of the power amount required by the composite computer device 1. That is, the BMC 3 of the CPU module 2 and the power consumption collecting part 51 as well as the necessary power calculating part 52 of the management module 5 work together to function as the necessary power amount obtaining device for obtaining the necessary power amount described above.

Further, the power supply unit specifying part 53 (the power supply unit specifying device) has a function of specifying a combination of the AC-DC power supply units 4 with which the necessary power amount calculated in the manner described above is satisfied and the operating efficiency can be improved, by referring to the power supply unit efficiency table 57. Now, the power supply unit efficiency table 57 and a method for specifying the combination of the power supply units 4 will be described in detail.

The power supply unit efficiency table 57 is a power amount-efficiency table for each of the AC-DC power supply units 4, which shows the efficiencies of the power amounts that can be outputted from the respective AC-DC power supply units 4. FIG. 4 shows an example thereof. In this exemplary embodiment, there are four AC-DC power supply units A1, A2, B1, and B2 of two different kinds having different output properties. Reference numerals A1 and A2 are the same kinds of units (power supply units A), and reference numerals B1 and B2 (power supply units B) are of different kinds from those. As shown in FIG. 4, the power amount-efficiency table shows, for each load that is the power amount supplied from each of the AC-DC power supply units, the efficiency that is a proportion of the output power amount with respect to the input power amount at the time where the respective load is supplied. In the case of the example shown in FIG. 4, shown are the efficiencies that are set in advance from the time of shipment and the like of the power supply units. However, as will be described later, the power amount-efficiency table is updated as necessary in accordance with the actual operating condition of the AC-DC power supply units 4. FIG. 5 is a graph of the load-efficiency of the two kinds of the AC-DC power supply units 4. As in a dotted line of FIG. 5, the AC-DC power supply units A (A1, A2) are the power supply units having the performance with the maximum output of 1500 W, and the efficiency changes according to the load. Further, as in a solid line of FIG. 5, the AC-DC power supply units B (B1, B2) are the power supply units having the performance with the maximum output of 2250 W, and the efficiency also changes according to the load.

Further, the power supply unit specifying part 53 extracts a single AC-DC power supply unit 4 or a combination of a plurality of AC-DC power supply units 4 based on the power supply unit efficiency table 57 shown in FIG. 4 and the necessary power amount calculated in the manner described above. Now, there is considered a case where the necessary power amount of the composite computer device 1 is calculated as 3600 W, for example. In this case, it is not possible to supply the necessary power amount only with one unit selected from the power supply units A1, A2, B1, and B2, so that the power supply unit specifying part 53 extracts a combination of two or more power supply units. When the two or more AC-DC power supply units are turned on, load is imposed upon each of the AC-DC power supply units equivalently in a dispersed manner. Therefore, in the above-described case, the power supply unit specifying part 53 extracts six kinds of combinations as the combinations of the power supply units, i.e., (1) two power supply units “B1, B2” (load: 1800 W), (2) three power supply units “A1, B1, B2” (load: 1200 W), (3) three power supply units “A2, B1, B2” (load: 1200 W), (4) three power supply units “A1, A2, B1” (load: 1200 W), (5) three power supply units “A1, A2, B2” (load: 1200 W), (6) four power supply units “A1, A2, B1, B2” (load: 900 W). Then, the power supply unit specifying part 53 obtains the efficiencies corresponding to the load imposed on each of the power supply units of each combination from the efficiency tables, and calculates the overall efficiency of the combination. That is, the overall efficiency is obtained by leveling the efficiencies of each of the power supply units.

For example in a case of the combination (1), the efficiencies of the power supply units “B1, B2” (load: 1800 W) are 87.90% and 87.90%, respectively, and the average efficiency is 87.90%. Further, in cases of the combinations (2) and (3), the efficiencies of the power supply units “A1 (or A2), B1, B2” (load: 1200 W) are 89.44%, 88.78%, and 88.78%, respectively, and the average efficiency is 89.00%. In cases of the combinations (4) and (5), the efficiencies of the power supply units “A1, A2, B1 (or B2)” (load: 1200 W) are 89.44%, 89.44%, and 88.78%, respectively, and the average efficiency is 89.22%. Furthermore, in a cases of the combination (6), the efficiencies of the power supply units “A1, A2, B1, B2” (load: 900 W) are 88.35%, 88.35%, 87.92%, and 87.92%, respectively, and the average efficiency is 88.14%.

Among those, the combination with the highest efficiency is the combination (4) or the combination (5) with the power supply units “A1, A2, and B1 (B2)”, so that the power supply unit specifying part 53 selects those combinations. In the above case, the two kinds of combinations exhibit the highest efficiency, so that the power supply specifying part 53 specifies an arbitrary combination from those. For example, the power supply unit specifying part 53 specifies the combination of the youngest numbers of the power supply units, “A1, A2, B1” as the power supply units. Then, the power supply unit specifying part 53 informs the specified combination of the power supply units to the power supply on/off control part 54.

Then, the power supply on/off control part 54 (power supply controller) controls on/off of each of the AC-DC power supply units 4 (A1, A2, B1) that are contained in the combination of the power supply units specified in the manner described above. That is, when operating the composite computer device 1, the power supply on/off control part 54 turns on the power of the AC-DC power supply units 4 (A1, A2, B1). Thereby, the power supply units for supplying the power can be used more efficiently, so that it is possible to increase the life of the power supply units and to decrease the power consumption further.

In the above, the combination of the highest efficiency among the all combinations of the power supply units is specified. However, the power supply unit specifying part 53 is not necessarily limited to specify the combination whose overall efficiency becomes the highest. For example, the power supply unit specifying part 53 may specify the combination in which one of the power supply units exhibits the highest efficiency. Further, while the case where the necessary power amount is equally divided by the number of the power supply units has been described, the necessary power amount is not necessarily divided equally. For example, when the load imposed upon each of the power supply units is determined according to the properties of the power supply units, the power supply specifying part 53 calculates the load imposed upon each of the power supply units according to the calculating formula that is set in advance in accordance with the properties, and calculates the respective efficiency corresponding to the calculated load.

Further, the power supply unit specifying part 53 may specify the combination of the power supply units in such a manner that the power supply units to be turned on can be in a redundant structure. That is, the power supply unit specifying part 53 may specify a combination that is configured by further adding a single power supply unit or a plurality of power supply units to the specified combination of the power supply units described above. Alternatively, the power supply unit specifying part 53 may specify a combination that can supply the necessary power amount with remaining power supply units even if one of the power supply units of the above-described combination becomes out of order by failure or the like. In the above-described case of the combination with the power supply units “A1, A2, B1”, it is not possible to supply the necessary power amount “3600 W” only with the power supply units A1 and A2 if the power supply unit B1 becomes out of order. Thus, the power supply unit specifying part 53 specifies a combination of four power supply units “A1, A2, B1, B2”, which is the combination obtained by adding another power supply unit B2 further to the above-described combination of the power supply units “A1, A2, B1”. The added power supply unit B2 is capable of supplying the power amount that can be supplied by any of the power supply units A1, A2, and B1, so that the power supply unit B2 can be substituted for any of those units. Therefore, even if the power supply of one unit becomes broken, it is possible to supply the necessary power amount with the remaining three power supply units. Thus, this is considered a redundant structure.

If the combination of the four units “A1, A2, B1, B2” is specified in the first place as the combination of the highest efficiency, the necessary power amount can be supplied with the three units even when one of the units becomes out of order. In such case, it is in a redundant structure form the first place, so that the power supply unit specifying part 53 specifies such combination. As described, the power supply units specifying part 53 may specify the combination of the highest efficiency among the combinations that are in the redundant structure.

Further, the table updating part 55 (table updating device) has a function of monitoring the operating condition of each AC-DC power supply unit 4 constantly or at a specific time interval, and updating the power supply unit efficiency table. Specifically, the table updating part 55 detects the on/off state, condition thereof (whether or not each unit is out of order), the input current amount, the input voltage, the output current amount, the output voltage, and the like of each of the AC-DC power supply units 4, and divides the product (output power amount) of the output voltage and the output current amount by the product (input power amount) of the input voltage and the input current amount so as to calculate the efficiency with each load. Then, the table updating part 55 stores the calculated efficiencies to the efficiency tables of the corresponding AC-DC power supply units, and updates the efficiency tables. Thereby, the power amount-efficiency tables of the corresponding power supply units are updated in accordance with the individual differences and the secular changes of each of the AC-DC power supply units. Thus, it is possible to specify the power supply units that exhibit the optimum efficiency, by corresponding to the conditions of the power supply units at each point and time. This makes it possible to achieve a more efficient use of the power supply units.

While the exemplary embodiment has been described that the BMC 3 executes the monitoring of the operating conditions of the CPU 21, the memory 22, the HDD 23, and the DC-DC power supply 24 loaded on the CPU module 2 and calculation of the power consumption of the CPU module 2, the present invention is not limited only to such case. Further, while there has been described the case where the management module 5 monitors the AC-DC power supply units 4 and controls on/off thereof, the present invention is not limited only to such case. Only a part of the above-described processing may be executed by the BMC 3 and the management module 5, or it may be executed by management software prepared externally.

### (Operations)

Next, operations of the composite computer device in the above-described structure will be described by referring to flowcharts of FIG. 6 and FIG. 7.

First, the BMC 3 of the CPU module 2 obtains CPU module structural information D1 showing the structure of the CPU module 2 and CPU module operation state information D2 showing the operation of the structure from each structural element of the mounted CPU module 2 (steps S1 and S2). As described above, the CPU module structural information D1 is the information regarding the loaded number of CPUs, the types of the CPUs, the loaded number of memories, and the loaded number of HDDs, for example. The CPU module operation state information D2 is the information regarding the on/off state of the CPUs, HDDs, and the like, regarding operation clocks of the CPUs, and regarding whether or not the CPUs are in a power saving mode.

Subsequently, the BMC 3 calculates the value of the power consumption amount of the CPU module 2 to which the BMC 3 is loaded based on the obtained CPU module structural information D1 and the CPU module operation state information D2, i.e., according to the loaded number of CPUs, the loaded number of memories, and the operation state, etc (step S3). Then, the BMC 3 transmits the calculated power consumption amount of the CPU module to the management module 5 (step S4). Each of the BMC 3 loaded on the respective CPU modules 2 executes such operation, and transmits the power consumption amount of respective CPU modules 2 to the management module 5.

Subsequently, the management module 5 collects the power consumption amounts of each CPU module 2 transmitted from each BMC 3 (step S5), and calculates the power consumption amount of the entire composite computer device 1 from the power consumption amounts of each of the CPU modules 2 (step S6). The power consumption amount of the entire composite computer device 1 is calculated by adding up the power consumption amounts of each of the CPU modules and other structural elements of the composite computer device 1, for example. Subsequently, the management module 5 calculates the power amount that is required by the entire composite computer device 1, i.e., the power amount that needs to be supplied from the AC-DC power supply units 4, based on the calculated power consumption amount of the entire composite computer device 1 (step S7: necessary power amount obtaining step) As the necessary power amount, the power consumption amount of the entire composite computer device 1 may be calculated as it is as the necessary power amount. Alternatively, a value obtained by adding the power amount of a single AC-DC power supply unit 4 to the entire power consumption amount may be calculated as the necessary power amount.

Further, the management module 5 monitors the operation state of each AC-DC power supply unit 4 at a specific time interval or at a timing set in advance, and obtains AC-DC power supply unit operation state information D3 (step S8). At this time, the management module 5 obtains the input power amount and the output power amount of each AC-DC power supply unit 4, for example, as the AC-DC power supply unit operation state information D3. Then, the management module 5 calculates the efficiency that is the proportion of the output power amount with respect to the input power amount for each of the AC-DC power supply units 4 (step S9), and stores each efficiency to the corresponding power supply unit efficiency table 57 (step S10: table updating step). As will be described later, for example, the management table 5 regularly turns on the power of the AC-DC power supply unit 4 that is not in operation because the power thereof is being turned off, and monitors the operating condition to update the power supply unit efficiency table thereof. In this manner, the information shown in FIG. 4 stored in the power supply unit efficiency table 57 is constantly updated by the above-described management module 5 by corresponding to the state of the power supply units 4. However, the power supply unit efficiency table 57 may not necessarily be limited to be updated by the management module 5. The information therein may be remained in the data that is originally registered in advance by a person in charge or the like, or it may be updated by the person in charge or the like.

The management module refers to the power supply unit efficiency tables 57, and determines the combination with which the necessary power amount calculated in the manner described above can be satisfied and the AC-DC power supply units can operate most efficiently (step S11: power supply unit specifying step). Then, the management module controls on/off in such a manner that only the AC-DC power supply units 4 which configure the determined combination can be in operation (step S12: power supply control step).

Now, the operation of the above-described management module 5 for determining the combination of the power supply units, i.e., the operation of step S10 shown n FIG. 6, will be described in more details by referring to the flowchart of FIG. 7. As in the above, it is assumed here that four units, i.e., two each of the two kinds of power supply units A (A1, A2) and power supply units B (B1, B2) in the properties as in FIG. 4, are loaded as the AC-DC power supply units 4. Further, it is assumed that the necessary power amount of the composite computer device 1 is calculated as 3600 W. Furthermore, it is assumed that the power amount supplied to the composite computer device 1, i.e., the load of the AC-DC power supply units 4, is divided equally for the power supply units that are being set on.

With the above-described condition, the management module first obtains all the combinations of the loaded power supply units (step S21). In this case, four AC-DC power supply units are loaded, so that there are sixteen combinations of on/off states of those units. Subsequently, among the combinations, the management module 5 extracts the combination with which the necessary power amount of the composite computer device 1 can be supplied (step S22). In the case of the aforementioned necessary power amount, it is not possible to satisfy the necessary amount with a single power supply unit or a combination of two power supply units including at least one of the power supply units A (A1, A2) Thus, the management module 5 extracts other combinations.

Therefore, as the combinations of the power supply units, the management module 5 can extract the six kinds of combinations as described above, i.e., (1) two power supply units “B1, B2” (load: 1800 W), (2) three power supply units “A1, B1, B2” (load: 1200 W), (3) three power supply units “A2, B1, B2” (load: 1200 W), (4) three power supply units “A1, A2, B1” (load: 1200 W), (5) three power supply units “A1, A2, B2” (load: 1200 W), (6) four power supply units “A1, A2, B1, B2” (load: 900 W). The values of the load within parentheses indicate the values of the load imposed equally to each of the power supply units of the respective combinations. The efficiencies corresponding to the load of each power supply unit in each combination are obtained from the efficiency tables, and the overall efficiency of the combination is calculated. That is, the overall efficiency is calculated by leveling the obtained efficiencies of each power supply unit (steps S23, S24, S25). With this, it is found that the combinations (4) and (5) exhibit the highest overall efficiency, and the combination (4) that has the power supply units of younger numbers is selected from the two combinations. Thereby, specified is the combination of the power supply units “A1, A2, B1” (step S26).

At this time, as described above, the combination of the power supply units may be so determined that the combination of the power supply units can be in a redundant structure, i.e., a structure with which the necessary power amount for the composite computer device 1 can be supplied with remaining power supply units even if a single power supply unit or a plurality of power supply units become out of order.

As described above, the exemplary embodiment specifies the combination of the power supply units which can supply the necessary power amount to the composite computer device 1 and exhibit the optimum efficiency, and controls on/off to supply the power from the specified power supply units. Therefore, it is possible to achieve an efficient use of the power supply units, thereby making it possible to increase the life of the power supply units and to decrease the power consumption.

Further, the power amount-efficiency tables are updated in accordance with the secular changes and the like of each power supply units, so that the power supply units that can provide the more optimum efficiency can be specified by corresponding to the conditions of the power supply units at each point and time. Therefore, it is possible to achieve a more efficient use of the power source units.

The present invention can provide such an excellent effect that it is possible to achieve highly efficient use of the power supply units so as to increase the life of the power supply units and to decrease the power consumption, which cannot be achieved with the conventional techniques.

### Second Exemplary Embodiment

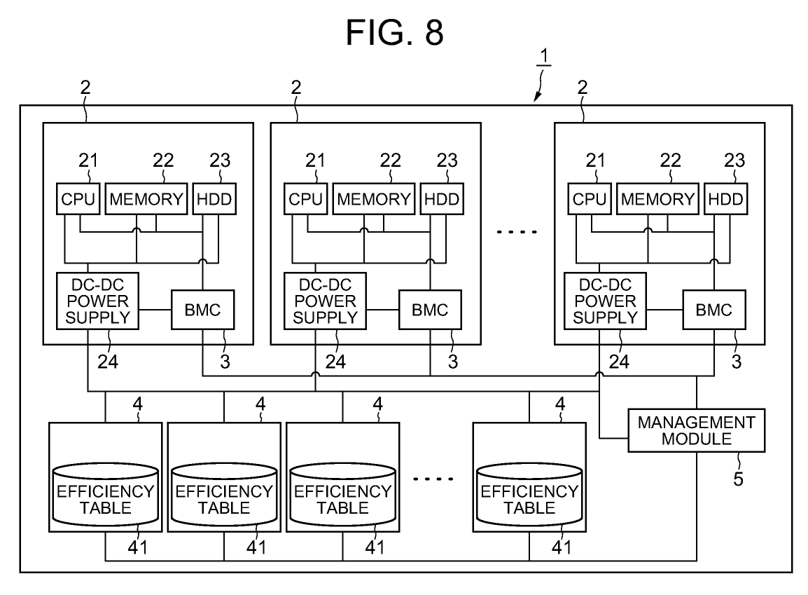

Next, a second exemplary embodiment of the invention will be described by referring to FIG. 8. FIG. 8 is a block diagram showing the structure of a composite computer device according to this exemplary embodiment.

As shown in FIG. 8, a composite computer device 1 according to this exemplary embodiment has almost the same structure as that of the device 1 described in the first exemplary embodiment. However, it is different in respect that each of the AC-DC power supply units 4 in the second exemplary embodiment stores a power supply unit efficiency table 41 that shows the relation between the power amount and the efficiency, which is the property of the unit itself. That is, the management module 5 according to the second exemplary embodiment does not have the power supply unit efficiency table 41 stored therein.

The power supply unit efficiency table 41 stored in each of the AC-DC power supply units 4 keeps efficiency data that shows the property of the own power supply unit of an initial state as it is manufactured, and it is stored in each power supply unit 4 at the time of shipment, for example. Further, the power supply unit efficiency table 41 stored in each of the AC-DC power supply units 4 can be read out by the power supply unit specifying part 53 of the management module 5 and, as described above, can be used when specifying the combination of the AC-DC power supply units of high efficiency.

With the above-described structure, the efficiency table to which efficiency information corresponding to the condition of the AC-DC power supply unit 4 is stored can be referred immediately after the AC-DC power supply unit 4 is loaded on the composite computer device 1, so that the composite computer device 1 can be operated with the combination of AC-DC power supply units that can provide still higher efficiency. Therefore, as in the above-described case, it is possible to save the power of the composite computer device 1. Further, it is unnecessary to perform update and the like of the data within the management module 5, so that it becomes easier to perform changes and the like of the device structure.

Further, the efficiency table 41 stored within the AC-DC power supply unit may be so structured that it can be rewritten by the management module 5. That is, the efficiency is updated by the table updating part 55 of the management module 5 in accordance with the operating condition of the monitored AC-DC power supply unit 4. Alternatively, the updating function of the table updating part 55 may be loaded on the AC-DC power supply unit itself, or may be loaded on other structures. With this, it becomes possible to refer to the appropriate efficiency information in accordance with the condition of each AC-DC power supply unit 4, even if an already-used AC-DC power supply unit is moved to another composite computer device or even if the management module is exchanged. Therefore, the composite computer device 1 can always be operated with the combination of the power supply units that can provide high efficiency.

While the present invention has been described by referring to a specific exemplary embodiment shown in the drawings, the present invention is not limited only to the exemplary embodiment described with the drawings. It is needless to say that any known structures can be employed as long as the effects of the present invention can be achieved.

### INDUSTRIAL APPLICABILITY

The present invention can be utilized for a device having a plurality of power supply units, e.g., a composite computer device, and it exhibits an industrial applicability.

What is claimed is:

1. A power supply control device for controlling on/off of a plurality of power supply units which supply power to a device, the power supply control device comprising:
a necessary power amount obtaining device which obtains a necessary power amount that shows a value of a power amount required by the device;
a power supply unit specifying device which extracts combinations of a single power supply unit or of a plurality of power supply units capable of supplying the necessary power amount, calculates an efficiency of the power amount that is supplied to the device from each of the power supply units of the respective combinations, and specifies a combination of the power supply units whose calculated efficiencies satisfy a preset condition; and
a power supply controller which executes a control in such a manner that the power is supplied to the device from the power supply units that configure the specified combination.

2. The power supply control device as claimed in claim 1, wherein the power supply unit specifying device calculates an overall efficiency of the whole power supply units that configure each of the combinations based on the calculated efficiencies of each of the power supply units, and specifies the combination whose overall efficiency satisfies a preset condition.

3. The power supply control device as claimed in claim 2, wherein the power supply unit specifying device specifies the combination of the power supply units that include the unit whose calculated efficiency is the highest or the combination whose calculated overall efficiency is the highest.

4. The power supply control device as claimed in claim 2, wherein the power supply unit specifying device calculates an efficiency that corresponds to a power amount obtained by dividing the necessary power amount by number of the power supply units configuring the combination, as the efficiency of each of the power supply units.

5. The power supply control device as claimed in claim 1, comprising a table updating device which obtains values of input power amounts and values of output power amount of each of the power supply units, respectively, and updates power amount-efficiency tables of each of the power supply units.

6. The power supply control device as claimed in claim 1, wherein the power supply unit specifying device specifies a combination that is obtained by adding still another power supply unit to a single power supply unit or a plurality of the power supply units configuring the specified combination.

7. The power supply control device as claimed in claim 6, wherein the power supply unit specifying device specifies a combination that is obtained by adding still another power supply unit, which can be substituted for any of the power supply units configuring the combination, to a single power supply unit or a plurality of the power supply units configuring the specified combination.

8. The power supply control device as claimed in claim 5, wherein the power supply unit specifying device specifies a combination with which, when a prescribed power supply unit among a single power supply unit or a plurality of the power supply units configuring the specified combination becomes out of order, the necessary amount can be supplied to the device with remaining power supply units.

9. The power supply control device as claimed in claim 1, wherein the power supply unit specifying device: extracts combinations of a single power supply unit or a plurality of power supply units capable of supplying the necessary power amount based on power amount-efficiency tables that show efficiencies of power amounts that can be outputted from each of the power supply units; calculates efficiencies of the power amounts supplied to the device from each of the power supply units of the respective combinations; and specifies the combination of the power supply units whose calculated efficiencies satisfy a preset condition.

10. The power supply control device as claimed in claim 1, wherein the necessary power amount obtaining device obtains device information that shows a structure and an operating condition of the device, calculates a power consumption amount of the entire device based on the device information, and obtains the calculated power consumption amount as the necessary power amount.

11. The power supply control device as claimed in claim 10, wherein, when the device is a composite computer device comprising a plurality of computer modules having at least a processor and a memory, the necessary power amount obtaining device calculates power consumption of each of the computer modules, respectively, and calculates an overall power consumption amount of the entire composite computer device.

12. A power supply mounted device, comprising power supply units, a power supplied device which operates by receiving supply of power from the power supply units, and a power supply control device which controls on/off of the power supply units, wherein:
each of the power supply units stores a power amount-efficiency table which shows an efficiency of a power amount that can be outputted therefrom; and
the power supply control device comprises
a necessary power amount obtaining device which obtains a necessary power amount that shows a value of a power amount required by the device,
a power supply unit specifying device which extracts combinations of a single power supply unit or of a plurality of power supply units capable of supplying the necessary power amount based on the power amount-efficiency tables, calculates an efficiency of the power amount that is supplied to the device from each of the power supply units of the respective combinations, and specifies a combination of the power supply units whose calculated efficiencies satisfy a preset condition, and
a power supply controller which executes a control in such a manner that the power is supplied to the power supplied device from the power supply units that configure the specified combination.

13. The power supply mounted device as claimed in claim 12, wherein each of the power amount-efficiency tables is stored within the respective power supply units.

14. A power supply control program for allowing a power supply control device, which controls on/off of a plurality of power supply units capable of supplying power to a prescribed device, to execute:
a function which obtains a necessary power amount that shows a value of a power amount required by the device,
a function which extracts combinations of a single power supply unit or of a plurality of power supply units capable of supplying the necessary power amount based on the power amount-efficiency tables, calculates an efficiency of the power amount that is supplied to the device from each of the power supply units of the respective combinations, and specifies a combination of the power supply units whose calculated efficiencies satisfy a preset condition, and
a function which executes a control in such a manner that the power is supplied to the power supplied device from the power supply units that configure the specified combination.

15. The power supply control program as claimed in claim 14, which allows the power supply control device to execute a function which calculates an overall efficiency of the whole power supply units that configure each of the combinations based on the calculated efficiencies of each of the power supply units, and specifies the combination whose overall efficiency satisfies a preset condition.

16. A power supply control method for controlling on/off of a plurality of power supply units capable of supplying power to a prescribed device, the method comprising:
obtaining a necessary power amount that shows a value of a power amount required by the device,
extracting combinations of a single power supply unit or of a plurality of power supply units capable of supplying the necessary power amount based on the power amount-efficiency tables, calculating an efficiency of the power amount that is supplied to the device from each of the power supply units of the respective combinations, and specifying a combination of the power supply units whose calculated efficiencies satisfy a preset condition, and
executing a control in such a manner that the power is supplied to the power supplied device from the power supply units that configure the specified combination.

17. The power supply control method as claimed in claim 16, which calculates an overall efficiency of the whole power supply units that configure each of the combinations based on the calculated efficiencies of each of the power supply units, and specifies the combination whose overall efficiency satisfies a preset condition.

18. Power supply control means for controlling on/off of a plurality of power supply units which supply power to a device, the power supply control means comprising:
necessary power amount obtaining means for obtaining a necessary power amount that shows a value of a power amount required by the device;
power supply unit specifying means for extracting combinations of a single power supply unit or of a plurality of power supply units capable of supplying the necessary power amount, calculates an efficiency of the power amount that is supplied to the device from each of the power supply units of the respective combinations, and specifies a combination of the power supply units whose calculated efficiencies satisfy a preset condition; and
power supply control means for executing a control in such a manner that the power is supplied to the device from the power supply units that configure the specified combination.

19. A power supply mounted device, comprising power supply units, a power supplied means for operating by receiving supply of power from the power supply units, and a power supply control means for controlling on/off of the power supply units, wherein:
each of the power supply units stores a power amount-efficiency table which shows an efficiency of a power amount that can be outputted therefrom; and
the power supply control means comprises
necessary power amount obtaining means for obtaining a necessary power amount that shows a value of a power amount required by the device,
power supply unit specifying means for extracting combinations of a single power supply unit or of a plurality of power supply units capable of supplying the necessary power amount based on the power amount-efficiency tables, calculating an efficiency of the power amount that is supplied to the device from each of the power supply units of the respective combinations, and specifying a combination of the power supply units whose calculated efficiencies satisfy a preset condition, and
power supply control means for executing a control in such a manner that the power is supplied to the power supplied means from the power supply units that configure the specified combination.
